(19) United States
(12) Patent Application Publication
(10) Pub. No.: US 2005/0189371 A1
(43) Pub. Date: Sep. 1, 2005

(54) Device and method for retaining and dispensing ammunition clips

(76) Inventor: Justin L. Harvey, Calabasas, CA (US)

Correspondence Address: Tim Cook;Law Office of Tim Cook P.C., P.O. Box 10107, Liberty, TX, 77575, US

(21) Appl. No.: 10/654,146

(22) Filed: Sep. 3, 2003

(51) Int. Cl. B65H 1/08; G07F 11/16

(52) U.S. Cl. 221/226

(57) ABSTRACT

A spring-loaded enclosure retains and dispenses a plurality of ammunition clips or magazines one at a time on command. The enclosure includes six walls, joined together as a parallelpiped, with an opening through which magazines are inserted and dispensed by the device. A biasing means, such as a spring, retains the clips under spring potential energy so that as one magazine or clip is dispensed, another is staged to take its place.

### FIELD OF THE INVENTION

The present invention relates generally to the field of ammunition magazines and, more particularly, to a device for holding a plurality of ammunition clips in order to dispense such clips one at a time easily and rapidly.

### BACKGROUND OF THE INVENTION

Users of small firearms, such as hunters, peace officers, and soldiers, often need to carry extra ammunition with them, other than the ammunition that is loaded within the weapon. This extra ammunition is often carried in clips or magazines wherein a predetermined number of cartridges is loaded under spring pressure. When the weapon must be reloaded, the expended clip or magazine is released and a pre-loaded magazine is inserted into the weapon.

As described in Groover, U.S. Pat. No. 6,202,908, various magazine holders and carriers mounted on the user's person have been developed to provide a convenient means for transporting and making available one or more spare ammunition magazines. Magazine carriers secure magazines in place and protect them against damage, malfunction, and/or loss, especially during the rigorous conditions commonly encountered in combat by military personnel in peace keeping operations by law enforcement.

Spare magazines are often needed during life-threatening combat situations, thus magazine carriers must allow rapid and easy access to a full magazine for reloading and resuming fire with minimal delay. In particular, magazine carriers must enable the release, access, and acquisition of a spare magazine with the non-firing free hand, while maintaining a grip on the firearm with the firing hand. For this reason, magazine carriers are typically mounted or fastened on a belt, vest, or other garment worn by the user, where it is within easy reach of the user's free hand. Failure to quickly reload a full magazine while engaged in a gun battle can mean serious injury, capture, and/or death.

One common example of a spare magazine carrier incorporates a top flap which folds down and over an exposed upper portion of a magazine seated within a pouch, much like a button down shirt pocket. Groover teaches an improvement of this common magazine carrier, providing a carrier frame for seating and supporting at least one ammunition magazine. A downwardly retractable flap covers and retains the magazine, and the flap includes an elastic member connecting a lower flap end with an upper flap end. However, the carrier of Groover still includes a flap of material over the magazine and the flap must be disengaged before the magazine can be accessed and mounted into the weapon. The process of disengaging the flap and releasing the magazine can take precious time when it is least available to the user.

Another type of magazine holder, shown and described in U.S. Pat. No. 5,617,582, includes a load bearing vest having pouches with corresponding flaps. A drawstring lifts and holds the flaps up and away from the pouch while the user accesses an ammunition magazine seated in the pouch. The problem with this design is that it still requires lifting a flap. Further, the flap obstructs access to the magazine because it is still essentially a top flap magazine carrier as described above.

In a third common magazine carrier design disclosed in U.S. Pat. No. 5,484,093, the top flap is eliminated altogether which obviates the obstruction problem caused by a top flap, and thus facilitates speedy access. The magazine pouch in the 093 patent utilizes a tensioning bolt 22 to friction fit a spare magazine in a main body portion 10. However, retention of magazines by friction fit can be unreliable, especially in rigorous combat situations. Intense physical movement and activity during combat can cause dislodging and loss of the magazine, which would otherwise have been retained by a protective flap or other catch mechanism. In this arrangement, therefore, security is sacrificed for speed and the magazine is always susceptible to damage or loss. Furthermore, even if the spare magazine is retained securely, the magazine pouch still only carrier a single spare magazine.

Thus, there remains a need for a spare magazine carrier mountable on a user's person which is capable of securely retaining a plurality spare ammunition magazines, and providing simple, immediate, and unobstructed access to magazines when needed. The present invention is directed to fulfilling this need in the art.

### SUMMARY OF THE INVENTION

The present invention addresses these and other drawbacks in the prior art by providing a spring-loaded enclosure adapted to retain and dispense a plurality of ammunition clips or magazines one at a time on command. The enclosure includes six walls, joined together as a parallelpiped, with an opening through which magazines are inserted and dispensed by the device. A biasing means, such as a spring, retains the clips under spring potential energy so that as one magazine or clip is dispensed, another is staged to take its place.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a top view of a magazine retaining and dispensing device of this invention.

FIG. 2 is a partial section view of the device, as seen along section lines 2-2 of FIG. 1, with the device loaded with spare magazines.

FIG. 3 is a section view of the device with a number of spare magazine already dispensed from the device.

FIG. 4 is a section view of the dispensing device of this invention, with magazine retained in the device in an orientation different than that of FIGS. 1-3 to provide a lower profile if desired.

### DETAILED DESCRIPTION OF A PREFERRED EMBODIMENT

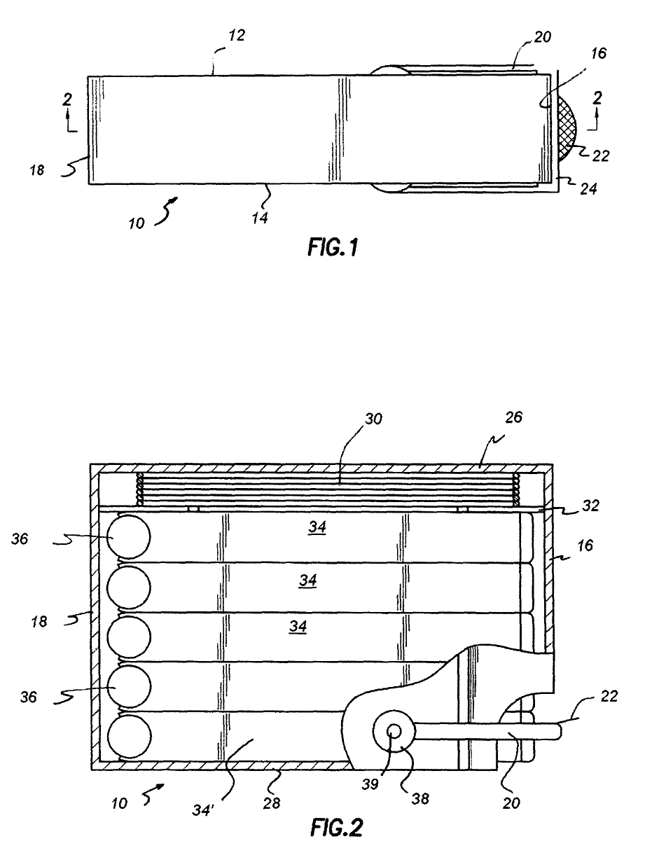

FIG. 1 shows a top view of a clip dispensing device 10 of the present invention. The device 10 is generally rectangular in configuration to retain a plurality of clips. As viewed in FIG. 1, the device comprises a pair of long opposing walls 12 and 14, and a pair of short opposing walls 16 and 18. The walls 12 through 18, inclusive, are preferably formed of a durable, non-spark producing material such as a metal alloy, and may even be made of a plastic. Positioned at one end of the device and adjacent the wall 16 is a dispensing bail 20 hingedly attached to walls 12 and 14. A knurled tab 22 is affixed to a crossbar 24 of the bail 20, thereby providing means for dispensing one magazine or clip from within the device as described below.

FIG. 2 shows a side elevation view of the device 10, as seen along section lines 2-2 of FIG. 1. As previously described, the device includes the pair of short opposing walls 16 and 18, and further includes a top 26 and a bottom 28. Along the underside of the top 26 is a biasing member 30, such as for example a spring as shown in FIG. 2. The biasing member 30 is compressed between the underside of the top 26 and a retainer plate 32 which presses down on a number of clips 34, five of which are illustrated in FIG. 2, although more or fewer such clips may be used. Each such clip 34 retains a plurality of ammunition cartridges 36.

In operation of the device, as the knurled tab 22 is pressed down, the bottom most clip 34′ is released. The knurled tab 22 rotates the bail 20 about an axis 38 under pressure from a biasing spring 39 to bring the bail 20 below the level of the bottom most clip 34′. This operation is illustrated in more detail in FIG. 3. With the bail 20 lowered as shown in FIG. 3, a clip is released to be withdrawn from the device 10 in a direction shown by an arrow 40. The biasing member 30 then forces the next clip down to the top surface of the bottom 28 so that it is positioned for the next release.

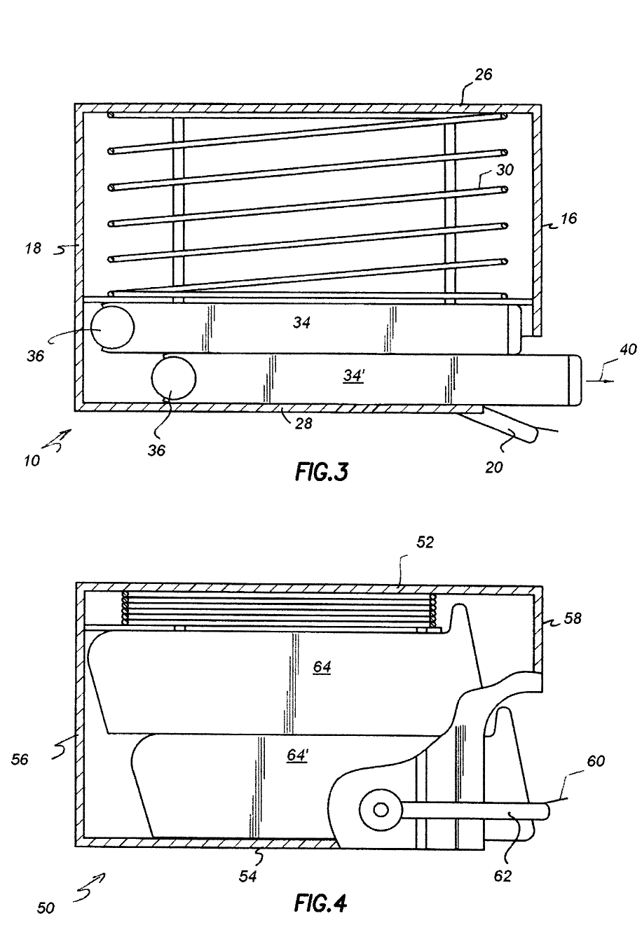

Finally, FIG. 3 illustrates the clips stacked inside the device 10 in a side by side orientation. However, FIG. 4 illustrates a device 50 having a top 52, a bottom 54, and sides 56 and 58 to form a parallelopiped. Clips are inserted and dispensed from the device 50 in an up and down orientation, thereby providing a thinner silhouette, but capable of retaining fewer clips as the device 10 previously described.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A device for retaining and dispensing ammunition clips comprising:
a. a top and a bottom;
b. left and right opposing sides;
c. a front and a back, the top, bottom, sides, front and back joined together to form a parallelopiped sized and oriented to retain at least two ammunition clips;
d. an opening through at least one of the top, bottom, sides, front, and back sized and oriented to receive and dispense an ammunition clip; and
e. a first biasing member within the parallelopiped to position an ammunition clip within the parallelopiped adjacent the opening.

2. The device of claim 1, further comprising a bail rotatably mounted to the device, the bail defining a quiescent position over the opening.

3. The device of claim 2, wherein the bail is held in the quiescent position by a biasing spring.

4. The device of claim 2, further comprising a knurled tab on the bail.

5. The device of claim 4, wherein the bail further defines an open position exposing an ammunition clip for dispensing from the device.

6. The device of claim 1, wherein the first biasing member comprises a spring.

7. The device of claim 1, wherein magazines are stacked within the device in a side by side orientation.

8. The device of claim 1, wherein the top, bottom, sides, front and back are formed of a metal alloy.

9. The device of claim 1, wherein the top, bottom, sides, front and back are formed of plastic.

10. The device of claim 1, further comprising a movable barrier moved by the first biasing member within the device.
